(19) United States
(12) Patent Application Publication
(10) Pub. No.: US 2017/0219047 A1
(43) Pub. Date: Aug. 3, 2017

(54) TORSION DAMPING ARRANGEMENT FOR THE POWERTRAIN IN A VEHICLE

(71) Applicant: ZF Friedrichshafen AG, Friedrichshafen (DE)

(72) Inventors: Uwe GROSSGEBAUER, Erlabrunn (DE); Thomas WEIGAND, Weikersheim (DE)

(21) Appl. No.: 15/328,770

(22) PCT Filed: Jun. 22, 2015
(86) PCT No.: PCT/EP2015/063918

§ 371 Date: Jan. 24, 2017

(30) Foreign Application Priority Data
Jul. 24, 2014 (DE) 10 2014 214 529.5
Apr. 28, 2015 (DE) 10 2015 207 825.6

(51) Int. Cl. F16F 15/131

(52) U.S. Cl. CPC F16F 15/13157; F16H 45/02

(57) ABSTRACT

A torsional vibration damping arrangement includes: an input region, an output region, and a coupling arrangement communicating with the output region. A phase shifter arrangement communicates with the input region. A torque transmission path extending between the input region and the output region transmits a total torque. The torque transmission path is divided into first and second torque transmission paths, which paths are guided back together again at the coupling arrangement. An input torsional vibration is divided into two torsional vibration components by being conducted respectively via the first and second torque transmission paths and are destructively superimposed at the coupling arrangement to form a minimized output torsional vibration relative to the input torsional vibration. A planet wheel carrier is constructed as a modular building block planet carrier element and includes at least a first connection area.

### CROSS-REFERENCE TO RELATED APPLICATIONS

This is a U.S. national stage of application No. PCT/EP2015/063918, filed on Jun. 22, 2015, which claims priority to the German Application Nos. 10 2014 214 529.5, filed 24 Jul. 2014; and 10 2015 207 825.6 filed 28 Apr. 2015, the content of all are incorporated herein by reference.

### BACKGROUND OF THE INVENTION

1. Field of the Invention

The present invention is directed to a torsional vibration damping arrangement for the powertrain of a vehicle, having an input region to be driven in rotation around an axis of rotation and an output region, there being provided between the input region and the output region a first torque transmission path and, parallel thereto, a second torque transmission path and a coupling arrangement for superposing the torques conducted via the torque transmission paths. A phase shifter arrangement is provided in the first torque transmission path for generating a phase shift of rotational irregularities conducted via the first torque transmission path relative to rotational irregularities conducted via the second torque transmission path.

2. Related Art

A generic torsional vibration damping arrangement known from German patent application DE 10 2011 007 118 A1 divides the torque introduced into an input region, for example, through a crankshaft of a drive unit, into a torque component transmitted via a first torque transmission path and a torque component conducted via a second torque transmission path. Not only is there a static torque divided with this torque division, but also the vibrations and rotational irregularities generated, for example, by the periodically occurring ignitions in a drive unit and contained in the torque to be transmitted are also divided proportionately into the two torque transmission paths. The torque components transmitted via the two torque transmission paths are brought together again in a coupling arrangement and are then introduced as total torque into the output region, for example, a friction clutch or the like.

A phase shifter arrangement constructed in the manner of a vibration damper, i.e., with a primary side and a secondary side rotatable with respect to the primary side through the compressibility of a spring arrangement, is provided in at least one of the torque transmission paths. In particular when this vibration system passes into a supercritical state, i.e., when it is excited by vibrations exceeding the resonant frequency of the vibration system, a phase shift of up to 180° occurs. This means that at maximum phase displacement the vibration components proceeding from the vibration system are shifted in phase by 180° with respect to the vibration components received by the vibration system. Since the vibration components conducted via the other torque transmission path do not undergo a phase shift or, if so, a different phase shift, the vibration components contained in the unified torque components and then shifted in phase with respect to one another are destructively superposed on one another such that, ideally, the total torque introduced into the output region is a static torque that contains essentially no vibration components.

### SUMMARY OF THE INVENTION

Proceeding from the background art cited above, it is an object of the present invention to construct a torsional vibration damping arrangement, preferably with axially narrow installation spaces, in the form of a modular system configured such that it comprises mutually compatible structural component parts.

This object is met, according to one aspect of the invention, through a torsional vibration damping arrangement for the powertrain of a motor vehicle comprising an input region to be driven in rotation around a rotational axis (A) and an output region, the input region comprising a primary mass and the output region comprising a secondary mass and a coupling arrangement that communicates with the output region, the coupling arrangement comprises a planetary gear unit with a planet wheel carrier, planet wheel pin and a planet wheel element, and with a first input element, a second input element and an output element, and a torque transmission path for transmitting a total torque, which torque transmission path extends between the input region and the output region. The torque transmission path from the input region to the coupling arrangement is divided into a first torque transmission path for transmitting a first torque component and a parallel, second torque transmission path for transmitting a second torque component. The first torque transmission path, the second torque transmission path and, therefore, the first torque component and the second torque component are guided together again at the coupling arrangement in an output torque, and a phase shifter arrangement in the first torque transmission path comprising a vibration system with a first stiffness, wherein the first stiffness comprises a spring arrangement, and wherein an input torsional vibration proceeding from the input region is divided into a first torsional vibration component and a second torsional vibration component by being conducted via the first torque transmission path and via the second torque transmission path, and wherein during an operation of the vibration system in a speed range above at least one limit speed at which the vibration system is operated in a resonant range, the first torsional vibration component and the second torsional vibration component are superimposed at the coupling arrangement such that the first torsional vibration component and the second torsional vibration component are destructively superimposed, and an output torsional vibration which is minimized relative to the input torsional vibration is accordingly present at the output element of the coupling arrangement. The planet wheel carrier is constructed as a modular building block planet carrier element and comprises at least a first connection area radially outwardly of a fastening of the planet wheel pin at the planet wheel carrier, by which first connection area the modular building block planet carrier element is connected to the primary mass so as to be fixed with respect to rotation relative to it.

The primary mass of the torsional vibration damping arrangement can be connected to—in this case, for example—the crankshaft so as to be fixed with respect to rotation relative to the crankshaft and to a control plate likewise so as to be fixed with respect to rotation relative to the control plate. Further, the planet wheel carrier of the coupling arrangement, which is advantageously formed of a carrier element, and a flange element is connected to the primary mass likewise so as to be fixed with respect to rotation relative to the primary mass and consequently forms a part of the primary mass. The connection can advantageously be realized by a plurality of crankshaft screws arranged at the circumference. Together with the planet wheels, these components make up a primary side of the power-split. A spring arrangement of the phase shifter arrangement is controlled by the primary mass via at least one control plate. An output of the phase shifter arrangement is connected to an input ring gear element so as to be fixed with respect to rotation relative to the input ring gear element. The input ring gear element can comprise an input ring gear carrier and an input ring gear or may be produced from one structural component part. The spring arrangement of the phase shifter arrangement transmits the torque to the input ring gear carrier. An input ring gear is located at the input ring gear carrier so as to be fixed with respect to rotation relative to it. In addition, an additional mass can be arranged at the input ring gear carrier so as to be fixed with respect to rotation relative to the input ring gear carrier in order to increase the mass moment of inertia. The stepped or non-stepped planet wheels are rotatably mounted on the planet wheel carrier connected to the primary mass so as to be fixed with respect to rotation relative to the planet wheel carrier. These planet wheels mesh with the input ring gear and an output ring gear connected to an output ring gear carrier so as to be fixed with respect to rotation relative to it and can be designated collectively as output element. An output flange element is connected to the output ring gear carrier so as to be fixed with respect to rotation relative to the output ring gear carrier. A rotationally locked connection to a transmission input shaft, a friction clutch, a converter or a similar unit can be positioned at this output flange element via a spline, for example.

An inner region of the torsional vibration damping arrangement, which can also be designated as common wet space of a phase shifter arrangement and a coupling arrangement, is sealed with respect to a surrounding area by a first seal element and a second seal element. The sealing is configured such that a viscous medium located in the interior of the torsional vibration damping arrangement for lubrication and/or cooling cannot reach the surrounding area. The first seal element is positioned between a flange element and a radially inwardly guided lengthening of the output planet wheel carrier. The second seal element is positioned between the output flange element and a cover element which is connected to the primary mass so as to be fixed with respect to rotation relative to the primary mass. In order to facilitate the insertion of the crankshaft screws, the output flange element is provided with one or more bore holes, which allow access to the crankshaft screws.

In an advantageous manner, both the control plate of the phase shifter arrangement and the planet wheel carrier of the coupling arrangement are connected to the primary mass. The planet wheel carrier is constructed as the modular building block planet carrier element which, as a standardized structural component part, can be combined with different embodiment forms of the torsional vibration damping arrangement. The modular building block planet carrier element is constructed so as to comprise in a radially outer region a first connection area at which the primary mass is fastened so as to be fixed with respect to relative rotation. This is advantageously carried out by a weld joint or other suitable connection such as a screw connection or a rivet connection. In an advantageous embodiment form, the connection is carried out so as to be impermeable to a viscous medium. In a radially inner region, the modular building block planet carrier element is formed as a fastening flange by which the modular building block planet carrier element can be connected to a crankshaft of a drive unit. As a result of the possibility of combining the modular building block planet carrier element with the primary mass, the various requirements of the wide variety of drive units can be dealt with in a simple and economical fashion. For example, the modular building block planet carrier element can be combined with differently configured phase shifter arrangements. It is also possible to combine the first component part element with the phase shifter arrangement with different second component part elements, for example, with differently adapted planetary gear units. This has an advantage that the entire torsional vibration damping arrangement need not be altered for a different vibration damping behavior but rather only a portion thereof.

Advantageous configurations and further developments of the invention are indicated in the dependent claims.

In an advantageous construction, the first input element of the coupling arrangement is connected to an output element of the phase shifter arrangement and the planet wheel element, and the second input element of the coupling arrangement is connected to the input region and the planet wheel element, and the planet wheel element is connected to the first input element, the second input element and the output element, and the output element forms the output region. In so doing, the first torque component and the first torsional vibration component are conducted to the planet wheel element of the coupling arrangement via the first torque transmission path by the first input element, whereas the second input element conducts the second torque component and the second torsional vibration component rigidly to the planet wheel element by the second torque transmission path. The first torque component and the second torque component and the first torsional vibration component and the second torsional vibration component are guided together again or, more precisely, superimposed at the planet wheel element and conveyed to the output element as output torque and as output torsional vibration. In an advantageous embodiment, for example, the output element can receive a friction clutch.

In order to achieve the phase shift in a simple manner in one of the torque transmission paths, the phase shifter arrangement preferably comprises a vibration system with a primary mass and an intermediate element rotatable with respect to the primary mass around the axis of rotation A against the action of a spring arrangement. A vibration system of this type can be constructed as a kind of vibration damper, known per se, in which the resonant frequency of the vibration system can be adjusted in a defined manner, particularly by influencing the primary-side mass and secondary-side mass as well as the stiffness of the spring arrangement, and the frequency at which there is a transition to the supercritical state can accordingly also be determined.

In a further advantageous embodiment form, the modular building block planet carrier element comprises a fastening region by which the modular building block planet carrier element is connected to the input region so as to be fixed with respect to rotation relative to it. The input region is advantageously formed by a fastening at a crankshaft of a drive unit. The above-mentioned fastening region of the modular building block planet carrier element is preferably located in a radially inner region and is provided with a fastening geometry corresponding to the crankshaft. Consequently, in an advantageous construction the modular building block planet carrier element is fastened by the fastening region to the crankshaft so as to be fixed with respect to rotation relative to the crankshaft by a screw joint. Accordingly, the modular building block planet carrier element produces the connection to the crankshaft of the drive unit on the one hand and, on the other hand, it is installed in the torsional vibration damping arrangement as part of the primary mass. In an advantageous construction, the first fastening region of the modular building block planet carrier element is connected radially outwardly to the primary mass so as to be fixed with respect to rotation relative to the primary mass, and the primary mass forms a receiving region for the spring arrangement of the phase shifter arrangement.

In a further advantageous embodiment form, the modular building block planet carrier element comprises a second connection area by which the modular building block planet carrier element is connected to a connection element of the input region so as to be fixed with respect to rotation relative to the connection element. This is especially advantageous because the modular building block planet carrier element can be applied for an even broader field of application for torsional vibration damping arrangements, since the modular building block planet carrier element can be fastened, for example, to a crankshaft by the connection element. Consequently, the connection element, which can be configured based on a suitably corresponding fastening geometry of the crankshaft, forms an interface between the drive unit and the torsional vibration damping arrangement. This is advantageous because it is therefore not the modular building block planet carrier element that needs to have a corresponding fastening geometry, but rather the connection element. The rotationally locked connection between the connection element and the modular building block planet carrier element is carried out via the second connection area, which is preferably effected by a radially extending weld seam. It is advantageous when the weld seam for the connection between the connection element and the modular building block planet carrier element is constructed so as to be impermeable to a viscous medium. However, another known connection method, e.g., riveting, screwing, or similar suitable joining method can also be selected.

In a further advantageous embodiment form, the first connection area and the second connection area are constructed so as to be impermeable to a viscous medium. The torsional vibration damping arrangement encloses a spatial region that may also be designated as wet space. For reduced friction and reduced wear, the spatial region within the torsional vibration damping arrangement is advantageously provided with a viscous medium such as oil or grease.

In order to prevent the escape of viscous medium, the first connection area and second connection area of the modular building block planet carrier element with respect to the primary mass and to the connection element are connected to one another such that no viscous medium can exit through the connection.

A further advantageous embodiment form provides that the torsional vibration damping arrangement has a torque converter and a lockup clutch. The torsional vibration damping arrangement can also be used in combination with an automatic transmission. To this end, the torque converter and the lockup clutch are combined with the torsional vibration damping arrangement. On principle, a distinction must be made between a torque transmission path with an open lockup clutch and a torque transmission path with a closed lockup clutch. The torque transmission path with the open lockup clutch extends, for example, from the crankshaft via the primary mass, which is connected to the latter so as to be fixed with respect to rotation relative to it, and an impeller of the torque converter, which is connected to the latter so as to be fixed with respect to rotation relative to it. The torque arrives, for example, at a transmission input shaft via a turbine which is connected to an output flange element so as to be fixed with respect to rotation relative to the output flange.

When the lockup clutch is closed, the torque travels from the crankshaft into the primary mass. On the one hand, the lockup clutch is connected to the primary mass so as to be fixed with respect to rotation relative to the primary mass. An output element of the lockup clutch is connected to the modular building block planet carrier element so as to be fixed with respect to rotation relative to the modular building block planet carrier and to the at least one cover plate so as to be fixed with respect to rotation relative to the at least one cover plate. The torque is divided here into two torque components. The first torque component is conducted via the cover plate into a spring set which can be arranged in one or more rows. From the spring set, the first torque is advantageously conducted via an input ring gear carrier and an input ring gear connected to the latter so as to be fixed with respect to rotation relative to it to a planet wheel of a planetary gear unit, which is rotatable fastened to the modular building block planet carrier element. The second torque component is guided from the output element of the lockup clutch directly to a planet wheel carrier of the modular building block planet carrier element and accordingly arrives at the planetary gear unit, where it is superposed with the first torque component. The torque superimposed in this way is advantageously guided to the output flange element and, therefore, to a transmission input shaft, for example, via an output ring gear and an output ring gear carrier connected to the latter so as to be fixed with respect to rotation relative to it and connected to the turbine again so as to be fixed with respect to rotation relative to it. Consequently, the modular building block planet carrier element can also be used as standardized component part for the case of application in which the torsional vibration damping arrangement is combined with the torque converter and lockup clutch. This is particularly advantageous with regard to reduced production costs and for using as many carry over parts as possible in the different cases of application of the torsional vibration damping arrangement, for example, in combination with a manual shift transmission, in combination with an automatic shift transmission, with an automatic gearbox, with a hybrid gearbox, or also with a dual clutch transmission.

### BRIEF DESCRIPTION OF THE DRAWINGS

Preferred embodiment examples of the invention will be described in the following with reference to the accompanying drawings. In the drawings:

FIG. 1 is a torsional vibration damping arrangement with a modular building block planet carrier element and a first connection area;

FIG. 2 is a torsional vibration damping arrangement as in FIG. 1, but with a second connection area;

FIG. 3 is a torsional vibration damping arrangement as in FIG. 1, but with a different position of the seal elements and a modified cover element;

FIG. 4 is a detail in the area of the phase shifter arrangement;

FIG. 5 is a torsional vibration damping arrangement, but in combination with a torque converter and a lockup clutch;

FIG. 6 is a torsional vibration damping arrangement as described in FIG. 1, but with a modified cover element;

FIG. 7 is a torsional vibration damping arrangement as described in FIG. 1, but with a modified cover element; and

FIG. 8 is a torsional vibration damping arrangement with a modular building block planet carrier element in connection with a two-row phase shifter arrangement.

### DETAILED DESCRIPTION OF THE PRESENTLY PREFERRED EMBODIMENTS

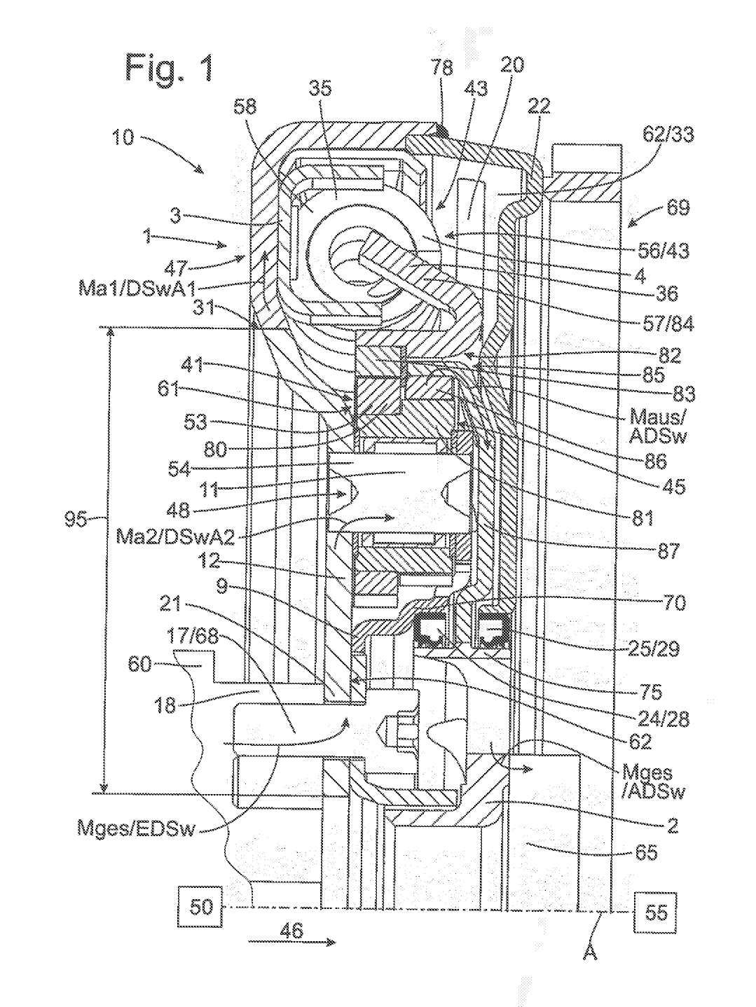

FIG. 1 shows a torsional vibration damping arrangement 10 that operates on the principle of power splitting or torque splitting. The torsional vibration damping arrangement 10 can be arranged in a powertrain of a vehicle between a drive unit 60 and the following segment of the powertrain, i.e., for example, a starting element 65 such as a friction clutch, a hydrodynamic torque converter or the like.

The torsional vibration damping arrangement 10 comprises an input region, designated generally by 50. This input region 50 can be connected, for example, as in the present case, through a crankshaft 18 of a drive unit 60 configured as an internal combustion engine. In the input region 50, the torque received by the drive unit 60 splits into a first torque transmission path 47 and a second torque transmission path 48. In the region of a coupling arrangement, designated generally by reference numeral 41, the torque components guided via the two torque transmission paths 47, 48 are introduced into the coupling arrangement 41 by a first input element 53 and a second input element 54 and are guided together again and then conveyed to an output region 55.

A vibration system, designated generally by reference numeral 56, is integrated in the first torque transmission path 47. The vibration system 56 operates as phase shifter arrangement 43 and comprises a primary mass 1, which is to be linked, for example, to the drive unit 60, and an intermediate element 57, which guides the torque farther and which is constructed in this instance as an input ring gear carrier 84 at which an additional mass 20 can also be arranged so as to be fixed with respect to rotation relative to the input ring gear carrier 84 as is also shown in FIG. 1. The primary mass 1 and a cover element 22, which are connected to one another, preferably by a weld joint 78, so as to be fixed with respect to rotation relative to one another substantially completely enclose toward the radially outer side a spatial region 33 in which is received, with respect to the radial arrangement, a spring arrangement 4 for the vibration system 56. A starter gear 34 is fastened in this instance to the cover element 22 (see FIG. 3) so as to be fixed with respect to rotation relative to it, preferably by a weld joint. Alternatively, the starter gear 34 can also be fastened to the primary mass 1. The spring arrangement 4 comprises a plurality of spring arrangements 58 which are arranged successively in circumferential direction and possibly also so as to be nested one inside the other. Each spring arrangement preferably comprises at least one helical compression spring or bow spring. The spring arrangement 58 of the spring arrangement 4 is supported by a control plate 2 at the primary mass 1 on the one hand and at an input element 82 on the other hand, and in this case the input element 82 comprises the input ring gear carrier 84 and an input ring gear 83, which is connected to the latter so as to be fixed with respect to rotation relative to it. The input element 82 can also be fashioned from one structural component part, not shown here. The rotationally locked connection of input ring gear carrier 84 and input ring gear 83 is preferably carried out by a weld joint, a rivet connection, a screw joint, a glue joint, an interference fit, a positive engagement connection or a comparable joining method, or a combination of the joining methods mentioned above. The input ring gear 83 guides the torque that was guided via the first torque transmission path 47 and, therefore, via the phase shifter arrangement 43 to a planet wheel element 45 of the coupling arrangement 41. In this case, the planet wheel element 45 comprises an input planet wheel 80 and an output planet wheel 81 arranged so as to be axially staggered. The input ring gear 83, which meshes with the input planet wheel 80, constitutes the first input element 53 of the coupling arrangement 41.

In the second torque transmission path 48, the torque is guided proceeding from the drive unit 60 via the crankshaft 18 into the second input element 54. This second input element 54 is connected, preferably by a screw joint 68, in this case by the crankshaft screw 17, to the crankshaft 18 so as to be fixed with respect to rotation relative to the crankshaft and forms the carrier element 12 of the planet wheel carrier 9 of the coupling arrangement 41. Accordingly, together with the flange element 70, the carrier element 12 and the flange element 70 form the actual planet wheel carrier 9. This is particularly advantageous because the planet wheel pin 11 is supported on both sides, i.e., at the carrier element 12 on the one hand and the flange element 70 on the other hand. This prevents a tilting of the planet wheel pin. The first torque transmission path 47, which is guided via the input ring gear 83 into the coupling arrangement 41, and the second torque transmission path 48, which is guided via the second input element 54 formed by the planet wheel carrier 9, are guided together to form one torque by the planet wheel element 45 of the coupling arrangement 41, which planet wheel element 45 is rotatably supported at the planet wheel carrier 9 by a planet wheel pin 11. The combined torque is conveyed via an output ring gear 86 and an output ring gear carrier 87, which is connected to the output ring gear carrier 86 so as to be fixed with respect to rotation relative to it and which output ring gear 86 and output ring gear carrier 87 together form an output element 85, to an output flange element 75, which is connected to the output ring gear carrier 87 so as to be fixed with respect to rotation relative to the output ring gear carrier 87 and which forms output element 49 in this instance and, from there, for example, is supplied to a secondary mass, not shown here, a friction clutch, or directly to a transmission.

A first seal element 24 and a second seal element 25 are used to seal a wet space 63 relative to a surrounding area 69, this wet space 63 preferably being filled with a viscous medium such as oil or grease to reduce friction and, therefore, wear. In this regard, the first seal element 24 is positioned between the output ring gear carrier 87 and a flange element 70. A relative rotation may take place between the output ring gear carrier 87 and the flange element 70. The first seal element 24, which is preferably constructed as a radial shaft sealing ring 28, can be installed between these two structural component parts and takes over a sealing function for the wet space 63 relative to the surrounding area 69 even though the output ring gear carrier 87 and the flange element 70 rotate relative to one another. The flange element 70 is connected to the planet wheel carrier 9 so that no viscous medium can escape to the surrounding area 69 from the wet space 63 at an area where the flange element 70 is connected to the planet wheel carrier 9. In addition, the flange element 70 is constructed such that it further supports the planet wheel pin 11. The planet wheel pin 11 is advantageously secured against tilting through this embodiment form.

The second seal element 25 is positioned between the cover element 22 and the output flange element 75. A relative rotation can take place between the cover element 22 and the output flange element 75. The second seal element 25, which is likewise preferably constructed as a radial shaft sealing ring 29, can seal the wet space 63 relative to the surrounding area 69 even when there is a relative rotation between the cover element 22 and the output flange element 75.

It is advantageous to use carry over parts to enable economical production. For this reason, the first seal element 24 and the second seal element 25 are constructed in this instance so as to be structurally identical. This results in advantages for purchasing component parts and for using a smaller number of assembly tools because only one size is used for the seal elements. However, different sizes of seal elements can also be used, although this is not shown in the drawing.

To allow even more carry over parts to be used for an economical production, the planet wheel carrier 9 is constructed as a modular building block planet carrier element 95 with a first connection area 31. The modular building block planet carrier element 95 is constructed in such a way that it can be installed as a standardized component part in combination with differently constructed connection component parts. This is particularly advantageous when the spring set 4 of the phase shifter arrangement 43 must be constructed differently because of different engine types. The modular building block planet carrier element 95 can then be connected by the first connection area 31, which is located radially outside in this instance to the primary mass 1, so as to be fixed with respect to rotation relative to it, which primary mass 1 also receives the spring set 4 in this instance. This is advantageously carried out by a weld joint or a similar known and suitable connection. This connection is advantageously constructed so as to be impermeable to a viscous medium.

In a radially inner region, the modular building block planet carrier element 95 is constructed as a fastening flange 21 in order to connect the modular building block planet carrier element 95 to the crankshaft 18 so as to be fixed with respect to rotation relative to it, preferably by crankshaft screws 17.

In an advantageous construction, a modular system of the torsional vibration damping arrangement 10 can be realized by dividing the primary mass 1 in two in this way.

FIG. 2 shows a torsional vibration damping arrangement 10 as in FIG. 1, but in which the modular building block planet carrier element 95 comprises an additional second connection area 32 located radially inside in this instance. As a result of this second connection area 32, the modular building block planet carrier element 95 can be standardized to an even greater degree because a connection to a corresponding crankshaft fastening geometry is no longer effected through the modular building block planet carrier element 95, but rather through a separate structural component part, such as a connection element 15, as in this case. The modular building block planet carrier element 95 is connected to the connection element 15 so as to be fixed with respect to rotation relative to it by the second connection area 32, preferably by a weld joint or another known and suitable connection, which is preferably impermeable to a viscous medium. As a result of this embodiment form, the modular building block planet carrier element 95 is available for an even broader embodiment form of different torsional vibration damping arrangements. Consequently, the modular building block planet carrier element 95 can be manufactured as a standardized component part.

FIG. 3 shows a torsional vibration damping arrangement 10 such as was already described in FIG. 1, but with a first seal element 24 and second seal element 25, and the first seal element 24 and second seal element 25 have different sizes. Further, the output flange element 75 is also rotatably mounted at the flange element 70 additionally by a bearing element 77 which can advantageously be constructed as a ball bearing. To this end, the cover element 22 is provided with a lateral stabilization geometry 23, which additionally forms a centering edge 26 for receiving a starter gear 34. The stabilization geometry 23 serves not only to receive the starter gear, but rather also serves to stabilize the cover element 22, which has a positive outcome during high centrifugal forces and is likewise beneficial for sealing with the second seal element 25 because the cover element 22 deforms less under the influence of centrifugal force due to the stabilization geometry.

FIG. 4 shows a detail from FIG. 3 in the region of the phase shifter arrangement 43. Advantageously shown therein is a formation 90, which is formed from the primary mass 1 by a shaping process, for example. The formation 90 receives the control plate 3 and can clamp or press the control plate 3 through a further shaping process. The formation 90 can be constructed like a rivet 91 formed from the primary mass 1. The advantages arise as a result of the fact that the formation 91 can be used as rivet 91 without needing to provide the primary mass with a bore hole for a rivet to pass through. This is particularly advantageous when this area is to be impermeable to a viscous medium. Alternatively, laser welding, soldering, a riveting process, a spot welding process or resistance welding can also be provided.

FIG. 5 shows a torsional vibration damping arrangement 10 with modular building block planet carrier element 95 installed in combination with a torque converter 88 and a lockup clutch 89. In this respect, two torque transmission paths must be distinguished on principle: the torque transmission with a closed lockup clutch 89 or with an open clutch 89. These two distinct torque transmission paths are known from the prior art. The torque transmission path with closed lockup clutch 89 will be addressed herein by preference. With closed lockup clutch 89, the torque introduced from the crankshaft 18 runs via the primary mass 1, via the lockup clutch 89 and via an output element 99 of the lockup clutch 89 to two cover plates 27. From this point, the torque is divided and is guided further via a first torque transmission path 47 and a second torque transmission path 48. In the first torque transmission path 47, the torque component is guided from the cover plates 27 via a radially inner spring arrangement 5 and via a hub disk 14 to a radially outer spring arrangement 4. Only one spring arrangement can also be installed, although this is not shown. Proceeding from the radially outer spring arrangement 4, the torque component arrives at a coupling arrangement 41 in the form of a planetary gear unit 61 in this instance via an input ring gear carrier 84 and via an input ring gear 83 connected to the latter so as to be fixed with respect to rotation relative to it.

The second torque transmission path 48 runs from the output element 99 of the lockup clutch 89 directly to a planet wheel carrier 9 of a modular building block planet carrier element 95. In this case, the modular building block planet carrier element 95 is connected by a first connection area 31, located radially outwardly in this case, by a rivet connection 64 to the output element 99 of the lockup clutch 89 so as to be fixed with respect to rotation relative to it.

Accordingly, one torque component is guided directly to the planetary gear unit, where it is reunited with and superposed with the torque component that was guided via the first torque transmission path 47. The reunited torque reaches an output flange element 72 by an output ring gear 86 connected to an output ring gear carrier 87 and a turbine 71 of the torque converter 88 so as to be fixed with respect to relative rotation. The output flange element 72 can be connected, for example, to a transmission input shaft, not shown.

FIG. 5 shows the configuration of the modular building block planet carrier element 95, which can also be installed in its embodiment form in torsional vibration damping arrangements without torque converters 88 as is shown in FIGS. 1 and 2. Accordingly, the advantages of the modular building block planet carrier element 95 result from its wide range of possible applications in combination with differently constructed component parts of a torsional vibration damping arrangement without requiring modification of the modular building block planet carrier element 95. This is particularly advantageous for an economical production.

FIG. 6 shows a torsional vibration damping arrangement 10 such as was already described in FIG. 1, but with a modified cover element 22. The aim is to form the cover element such that it deforms only minimally under the influence of a centrifugal force and such that the resulting enclosed space is as small as possible so that only a small amount of viscous material is required for lubrication. As has already been described, the rotationally locked connection between the cover element 22 and the primary mass 1 is to be constructed so as to be impermeable to the viscous material. The rotationally locked connection between the cover element and the primary mass is preferably carried out by a weld joint 78. A central position of the weld joint has the further advantage that the connection is located as far as possible from elevated stress concentrations in the corners.

FIG. 7 shows a torsional vibration damping arrangement 10 such as was already described with reference to FIG. 6, but with a modified cover element 22. The description referring to FIG. 6 also applies here for a configuration of the cover element 22. The cover plate 22 is to be constructed so as to be as stiff as possible. In this instance, the cover plate 22 has an additional centering structure 26 that can be used to receive a starter gear, not shown.

FIG. 8 shows a torsional vibration damping arrangement 10 that operates on the principle of power splitting or torque splitting as in FIG. 1. In contrast to the embodiment form shown in FIG. 1, the embodiment form in this case comprises a two-row phase shifter arrangement 44 with a first spring arrangement 51, arranged radially outwardly in this case, and a second spring arrangement 59 which is arranged radially inwardly of the first spring arrangement 51. The two spring sets 51 and 59 are connected in series. As has already been described referring to FIG. 1, the torsional vibration damping arrangement 10 comprises an input region 50. In the input region 50, the received torque branches into a first torque transmission path 47 and a second torque transmission path 48. In the region of the coupling arrangement 41, which can also be constructed in this instance as a planetary gear unit 61, the torque components Ma1 and Ma2, which are guided via the two torque transmission paths 47, 48, and the torsional vibration components DSwA1 and DsWA2 contained therein, are guided by a first input element 53 and a second input element 54 into the coupling arrangement 41 and guided together again and then conveyed onward to an output region 55 as an output torque Maus with an output torsional vibration ADSw contained therein.

The two-row phase shifter arrangement 44 with the first spring arrangement 51 and the second spring arrangement 59 is integrated in the first torque transmission path 47. The spring arrangements 51 and 59 can be formed of a plurality of helical compression springs arranged successively in circumferential direction and, depending on the embodiment form, also nested one inside the other or can also be constructed as bow springs. The first spring arrangement 51 is supported by control elements 6 connected to the primary mass 1 at the primary mass 1 on the one hand and at a hub disk 66 on the other hand. The second spring arrangement 59 is supported at the hub disk 66 on the one hand and at an intermediate element 57 on the other hand and with a cover plate 67 fixedly connected thereto. The input ring gear 83 is fastened by a connection element 73 to the intermediate element 57, which can also be designated as input ring gear carrier 84. so as to be fixed with respect to rotation relative to it. The use of the connection element 73 is only a constructional variant. The input ring gear can also be fastened directly to the intermediate element 57. The figure shows the additional masses 20 which, depending on embodiment form and required piece numbers, can be fastened to the intermediate element 57 so as to be fixed with respect to rotation relative to the intermediate element 57 in order to increase the mass moment of inertia of the intermediate element 57 so as to improve the functioning of the phase shifter arrangement. The also shows in this embodiment form with a two-row phase shifter arrangement 44 the modular building block planet carrier element 95 fastened to the primary mass 1 so as to be fixed with respect to rotation relative to it by means of a connection flange 74 in this case. The output is carried out in a known manner via an output ring gear 86 and an output ring gear carrier 87 to the output region 55. In this case, a disk element 79 that can receive a known friction disk clutch, not shown, is connected to the output ring gear carrier 87 so as to be fixed with respect to rotation relative to the output ring gear carrier 87. In another embodiment form, not shown herein, the disk element 79 can be omitted and the output ring gear carrier 87 can then be directly connected to the transmission, for example, a dual clutch transmission.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### REFERENCE CHARACTERS

1 primary mass
2 secondary mass
3 control plate
4 spring arrangement
5 spring arrangement
6 control element
9 planet wheel carrier
10 torsional vibration damping arrangement
11 planet wheel pin
12 carrier element
14 hub disk
15 connection element
17 crankshaft screw
18 crankshaft
20 additional mass
21 fastening flange
22 cover element
23 stabilization geometry
24 first seal element
25 second seal element
26 centering edge
27 cover plate
28 radial shaft sealing ring
29 radial shaft sealing ring
31 first connection area
32 second connection area
33 spatial region
34 starter gear
35 first stiffness
36 output element
41 coupling arrangement
43 phase shifter arrangement
44 two-row phase shifter arrangement
45 planet wheel element
46 torque transmission path
47 first torque transmission path
48 second torque transmission path
50 input region
51 first spring arrangement
52 superposition unit
53 first input element
54 second input element
55 output region
56 vibration system
57 intermediate element
58 spring arrangement
59 second spring arrangement
60 drive unit
61 planetary gear unit
62 fastening region
63 wet space
64 rivet connection
65 starting element
66 hub disk
67 cover plate
68 screw joint
69 surrounding area
70 flange element
71 turbine
72 output flange element
73 connection element
74 connection flange
75 output flange element
77 bearing element
78 weld joint
79 disk element
80 input planet wheel
81 output planet wheel
82 input element
83 input ring gear
84 input ring gear carrier
85 output element
86 output ring gear
87 output ring gear carrier
88 torque converter
89 lockup clutch
90 formation
91 rivet
95 modular building block planet carrier element
99 output element
A axis of rotation
Mges total torque
Ma1 torque component 1
Ma2 torque component 2
Maus output torque
EDSw input torsional vibration
DSwA1 torsional vibration component 1
DSwA2 torsional vibration component 2
ADSw output torsional vibration

1-7. (canceled)

8. A torsional vibration damping arrangement (10) for a powertrain of a motor vehicle, comprising:
an input region (50) arranged to be driven in rotation around an axis of rotation (A), the input region (50) including a primary mass (1);
an output region (55) including a secondary mass (20); and
a coupling arrangement (41) that communicates with the output region (55), the coupling arrangement (41) including a planetary gear unit (61) having a planet wheel carrier (9), a planet wheel pin (11), and a planet wheel element (45);
a first input element (53);
a second input element (54);
an output element (85);
a torque transmission path (46) configured to transmit a total torque (Mges), the torque transmission path (46) extending between the input region (50) and the output region (55), wherein the torque transmission path (46) from the input region (50) to the coupling arrangement (41) is divided into a first torque transmission path (47), for transmitting a first torque component (Ma1), and a parallel second torque transmission path (48), for transmitting a second torque component (Ma2), and wherein the first torque transmission path (47), and the second torque transmission path (48), and the respective first torque component (Ma1) and second torque component (Ma2), are guided back together at the coupling arrangement (41) to form an output torque (Maus); and
a phase shifter arrangement (43) in the first torque transmission path (47), the phase shifter arrangement (43) including a vibration system (56) with a first stiffness (35), the first stiffness (35) including a spring arrangement (4),
wherein an input torsional vibration (EDSw) proceeding from the input region (50) is divided into a first torsional vibration component (DSwA1) and a second torsional vibration component (DSwA2) by being conducted via the first torque transmission path (47) and via the second torque transmission path (48) respectively,
wherein during an operation of the vibration system (56) in a speed range above at least one limit speed at which the vibration system (56) is operated in a resonant range, the first torsional vibration component (DSwA1) is superposed with the second torsional vibration component (DSwA2) at the coupling arrangement (41) such that the first torsional vibration component (DSwA1) and the second torsional vibration component (DSwA2) are destructively superimposed, such that an output torsional vibration (ADSw) minimized relative to the input torsional vibration (EDSw) is present at the output element (85) of the coupling arrangement (41), and
wherein the planet wheel carrier (9) is constructed as a modular building block planet carrier element (95) and includes at least a first connection area (31) radially outwardly of a fastening of the planet wheel pin (11) at the planet wheel carrier (9), by which first connection area (31) the modular building block planet carrier element (95) is connected to the primary mass (1) so as to be fixed with respect to rotation relative to primary mass (1).

9. The torsional vibration damping arrangement (10) according to claim 8, wherein the first input element (53) of the coupling arrangement (41) is connected to an output element (36) of the phase shifter arrangement (43) and the planet wheel element (45), the second input element (54) of the coupling arrangement (41) is connected to the input region (50) and the planet wheel element (45), and the planet wheel element (45) is connected to the first input element (53), the second input element (54) and the output element (85), and wherein the output element (85) forms the output region (55).

10. The torsional vibration damping arrangement (10) according to claim 8, wherein the phase shifter arrangement (43) includes a vibration system (56) with the primary mass (1) and an intermediate element (57) rotatable with respect to the primary mass (1) around the axis of rotation (A) against the action of a spring arrangement (4).

11. The torsional vibration damping arrangement (10) according to claim 8, wherein the modular building block planet carrier element (95) includes a fastening region (62) by which the modular building block planet carrier element (95) is connected to the input region (50) so as to be fixed with respect to rotation relative to the input region (50).

12. The torsional vibration damping arrangement (10) according to claim 8, wherein the modular building block planet carrier element (95) comprises a second connection area (32) by which the modular building block planet carrier element (95) is connected to a connection element (15) of the input region (50) so as to be fixed with respect to rotation relative to the connection element (15) of the input region (50).

13. The torsional vibration damping arrangement (10) according to claim 12, wherein the first connection area (31) and the second connection area (32) are constructed so as to be impermeable to a viscous medium.

14. The torsional vibration damping arrangement (10) according to claim 8, wherein the torsional vibration damping arrangement (10) includes a torque converter (88) and a lockup clutch (89).
